(19) United States
(12) Patent Application Publication
(10) Pub. No.: US 2022/0099803 A1
(43) Pub. Date: Mar. 31, 2022

(54) SCANNER COVERED BY A DIFFRACTION GRATING FOR AN OPTICAL SENSING SYSTEM

(71) Applicant: BEIJING VOYAGER TECHNOLOGY CO., LTD., Beijing (CN)

(72) Inventors: Youmin WANG, Mountain View, CA (US); Yue LU, Mountain View, CA (US)

(73) Assignee: BEIJING VOYAGER TECHNOLOGY CO., LTD., Beijing (CN)

(21) Appl. No.: 17/033,625

(22) Filed: Sep. 25, 2020

(51) Int. Cl. G01S 7/481; G01S 17/89; G01S 17/931; G02B 26/10; G02B 26/12

(52) U.S. Cl. CPC G01S 7/4814; G01S 17/89; G02B 26/12; G01S 17/931; G02B 26/106; G01S 7/4817

(57) ABSTRACT

Embodiments of the disclosure provide systems and methods for steering optical beams in an optical sensing system. An exemplary transmitter of the optical sensing system includes an emitter configured to emit optical beams. The transmitter also includes a scanner configured to rotate around a rotation axis and steer the optical beams. The scanner includes a surface covered by a diffraction grating configured to diffract an incident optical beam non-orthogonal to the rotation axis of the scanner to form an outgoing optical beam substantially orthogonal to the rotation axis of the scanner.

### TECHNICAL FIELD

The present disclosure relates to optical sensing systems such as a light detection and ranging (LiDAR) system, and more particularly to, LiDAR systems having a scanner covered by a diffraction grating for steering the optical beams.

### BACKGROUND

Optical sensing systems such as LiDAR systems have been widely used in advanced navigation technologies, such as to aid autonomous driving or to generate high-definition maps. For example, a typical LiDAR system measures the distance to a target by illuminating the target with pulsed laser light beams and measuring the reflected pulses with a sensor such as a photodetector or a photodetector array. Differences in laser light return times, wavelengths, and/or phases can then be used to construct digital three-dimensional (3D) representations of the target. Because using a narrow laser beam as the incident light can map physical features with very high resolution, a LiDAR system is particularly suitable for applications such as sensing in autonomous driving and high-definition map surveys.

The pulsed optical beams (e.g., laser beams) emitted by a LiDAR system are typically directed to multiple directions to scan a field of view (FOV). For example, a scanner of the LiDAR system may be configured to scan the FOV by rotating around a rotation axis.

When scanning the FOV, the outgoing optical beams of the scanner needs to be substantially orthogonal to the rotation axis of the scanner. Otherwise, the scanning path would show a curved pattern instead of a linear one. Curved scanning path may cause distortions in perception. For example, a curved scanning path leads to distorted point cloud data, which in turn causes inaccuracy in the LiDAR observation. Curved scanning path may also lead to reduced effective FOV. Therefore, when merging data of different FOVs scanned by a curved scanning path, the FOVs have to be truncated due to reductions in the effective FOV.

FIG. 1 shows a conventional scanner 100 that uses mirror(s) with a flat surface 101. The internal layout design of those components within the LiDAR system is often limited by the size of each internal component of the LiDAR system. For example, in order not to be blocked by other components, the emitter (e.g., an emitter 106) may be located at a place that cannot emit beams orthogonal to the rotation axis (e.g., a rotation axis 103) of the scanner (scanner 100) at all scanning angles. As shown by FIG. 1, when incident optical beams 107 from emitter 106 are not substantially orthogonal to rotation axis 103 of the scanner, outgoing optical beams 109-1 and 109-2 reflected by flat surface 101 are not substantially orthogonal to rotation axis 103 of the scanner. As a result, the scanning path (e.g., a beam scanning path 110) formed by outgoing optical beams at different scanning angles (e.g., optical beams 109-1 and 109-2) is curved, which may significantly reduce the quality of detection.

### SUMMARY

Embodiments of the disclosure provide a transmitter of an optical sensing system. The transmitter includes an emitter configured to emit optical beams. The transmitter also includes a scanner configured to rotate around a rotation axis and steer the optical beams. The scanner includes a surface covered by a diffraction grating configured to diffract an incident optical beam non-orthogonal to the rotation axis of the scanner to form an outgoing optical beam substantially orthogonal to the rotation axis of the scanner.

Embodiments of the disclosure also provide a method for scanning an object using an optical sensing system. The method includes emitting an optical beam, by an emitter, incident on a scanner non-orthogonal to a rotation axis of the scanner. The method also includes diffracting the incident optical beam, by the scanner, to form an outgoing optical beam. The outgoing optical beam has components of a plurality of orders, and the component of a predetermined order is substantially orthogonal to the rotation axis of the scanner. The method further includes steering the component of the predetermined order of the outgoing optical beam to scan the object.

Embodiments of the disclosure further provide an optical sensing system. The system includes an emitter configured to emit optical beams. The system further includes a scanner configured to rotate around a rotation axis and steer the optical beams. A surface of the scanner is covered by a diffraction grating configured to diffract an incident optical beam non-orthogonal to the rotation axis of the scanner to form an outgoing optical beam substantially orthogonal to the rotation axis of the scanner. The system also includes a receiver configured to detect steered optical beams reflected by an object.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary conventional scanner for scanning an object.

FIG. 2 illustrates a schematic diagram of an exemplary vehicle equipped with a LiDAR system, according to embodiments of the disclosure.

FIG. 3 illustrates a block diagram of an exemplary LiDAR system, according to embodiments of the disclosure.

FIGS. 4A and 4B each illustrates a schematic diagram of an exemplary scanner covered by a diffraction grating for scanning an object, according to embodiments of the disclosure.

FIG. 5 illustrates a flow chart of an exemplary method for steering optical signals using a scanner covered by a diffraction grating, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

The optical sensing system may be used to scan objects, and the detecting result (e.g., point cloud data) can be used for advanced navigation technologies, such as to aid autonomous driving or to generate high-definition maps. For example, the optical sensing system may include a transmitter configured to emit optical beams (e.g., laser beams) steered to scan an object and a receiver configured to receive/detect optical beams reflected by the object. The detected optical beams may be processed to obtain detecting results such as point cloud data.

In some embodiments, the transmitter may include one or more emitters, configured to emit optical beams. The transmitter may also include a scanner, configured to rotate around a rotation axis and steer the optical beams to scan an FOV. For example, outgoing optical beams of the scanner may transmit along a plurality of scanning angles within a scanning range. Different optical beams emitted by different emitters may be configured to scan different FOVs covering different scanning ranges (e.g., each with a 45-degree range, a 60-degree range, etc.). The scanning may obtain point cloud data which can be used for advanced navigation technologies, such as to aid autonomous driving or to generate high-definition maps.

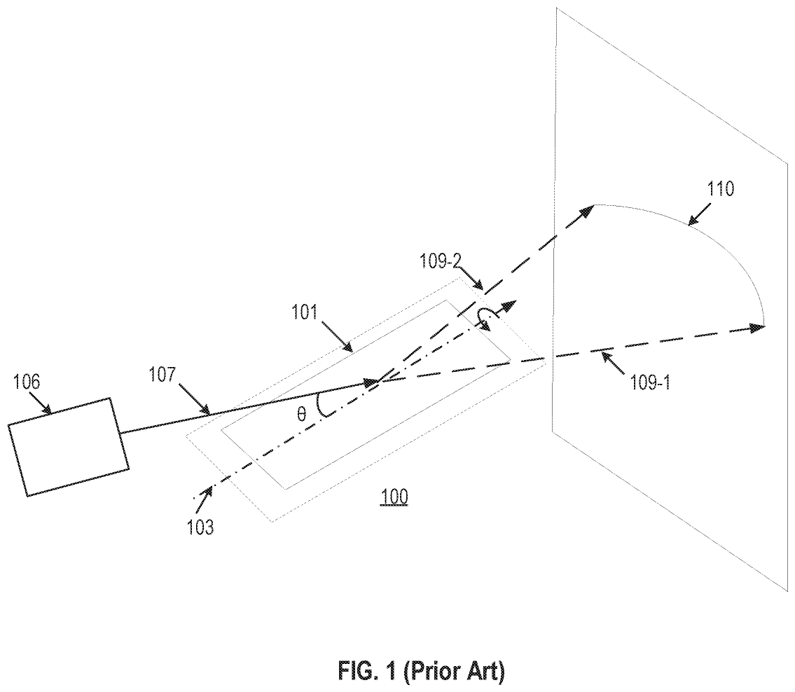

In some embodiments, point clouds captured in different FOVs may be merged to generate point clouds of an FOV with a larger range in angular degree (e.g., an FOV with 360-degree). In order to merge point clouds of different FOVs, the point clouds are better obtained by linear beam scanning paths. Curved beam scanning paths (e.g., as shown in FIG. 1) may cause distortions in generated point cloud data and reductions in effective FOV. For example, to compensate for such distortions, the scanned FOVs need to be overlapped when being merged.

In order to improve the linearity of the scanning path, the outgoing optical beams of the scanner need to be substantially orthogonal to the rotation axis of the scanner. Embodiments of the present disclosure provide systems and methods for scanning an object using an optical sensing system (e.g., a LiDAR system) with an improved scanner. The scanner may include a surface covered by a diffraction grating configured to diffract an incident optical beam non-orthogonal to the rotation axis of the scanner to form an outgoing optical beam substantially orthogonal to the rotation axis of the scanner. Accordingly, emitter(s) of the transmitter may be more flexibly placed in the LiDAR. For example, they no longer need to be placed to emit beams orthogonal to the rotation axis of the scanner to reduce/eliminate the scanning curvature problem. This can significantly increase the accuracy and performance of the optical sensing system.

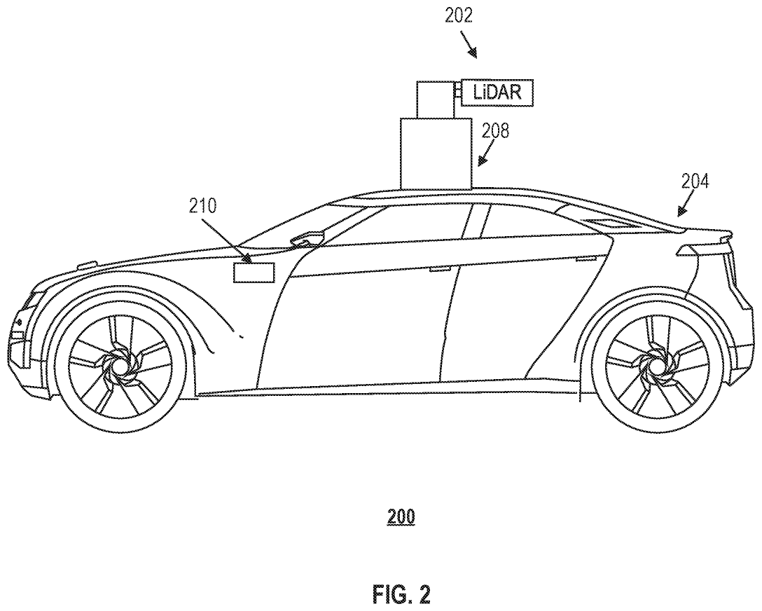

FIG. 2 illustrates a schematic diagram of an exemplary vehicle 200 equipped with an optical sensing system, e.g., a LiDAR system 202, according to embodiments of the disclosure. Consistent with some embodiments, vehicle 200 may be a survey vehicle configured for acquiring data for constructing a high-definition map or 3-D buildings and city modeling. Vehicle 100 may also be an autonomous driving vehicle.

As illustrated in FIG. 2, vehicle 200 may be equipped with LiDAR system 202 mounted to a body 204 via a mounting structure 208. Mounting structure 208 may be an electro-mechanical device installed or otherwise attached to body 204 of vehicle 200. In some embodiments of the present disclosure, mounting structure 208 may use screws, adhesives, or another mounting mechanism. Vehicle 200 may be additionally equipped with a sensor 210 inside or outside body 204 using any suitable mounting mechanisms. Sensor 210 may include sensors used in a navigation unit, such as a Global Positioning System (GPS) receiver and one or more Inertial Measurement Unit (IMU) sensors. It is contemplated that the manners in which LiDAR system 202 or sensor 210 can be equipped on vehicle 200 are not limited by the example shown in FIG. 2 and may be modified depending on the types of LiDAR system 202 and sensor 210 and/or vehicle 200 to achieve desirable 3D sensing performance.

Consistent with some embodiments, LiDAR system 202 and sensor 210 may be configured to capture data as vehicle 200 moves along a trajectory. For example, a transmitter of LiDAR system 202 may be configured to scan the surrounding environment. LiDAR system 202 measures distance to a target by illuminating the target with pulsed laser beam and measuring the reflected pulses with a receiver. The laser beam used for LiDAR system 202 may be ultraviolet, visible, or near infrared. In some embodiments of the present disclosure, LiDAR system 202 may capture point clouds including depth information of the objects in the surrounding environment. As vehicle 200 moves along the trajectory, LiDAR system 202 may continuously capture data.

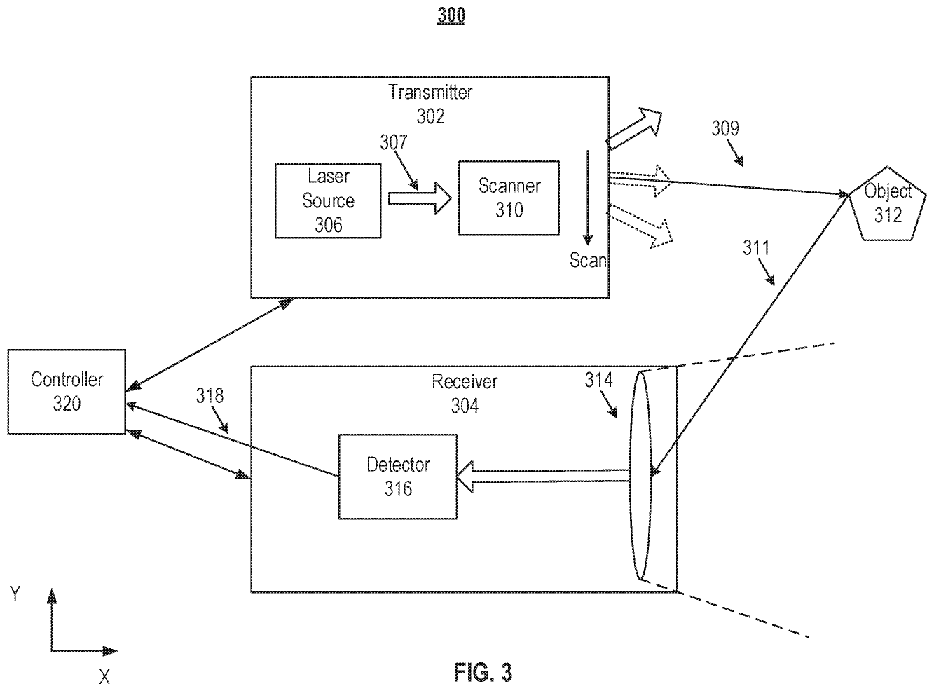

FIG. 3 illustrates a block diagram of an exemplary LiDAR system 300, according to embodiments of the disclosure. LiDAR system 300 may include a transmitter 302 and a receiver 304. Transmitter 302 may emit laser beams along multiple directions. Transmitter 302 may include one or more laser sources 306 (e.g., emitters) and a scanner 310. In some embodiments, laser sources 306 and scanner 310 may be separate devices or components. In other embodiments, laser sources 306 and scanner 310 may be integrated as a single device/component.

In some embodiments, transmitter 302 can sequentially emit a stream of pulsed laser beams in different directions (e.g., in different angles) within its scanning range as it moves (e.g., rotates, swings, etc.), as illustrated in FIG. 3. Laser source 306 may be configured to emit a laser beam 307 (also referred to as a “incident laser beam” with respect to scanner 310) in a respective incident direction to scanner 310. In some embodiments, laser source 306 may be disposed within scanner 310. In some embodiments of the present disclosure, laser source 306 may generate a pulsed laser beam in the ultraviolet, visible, or near infrared wavelength range.

In some embodiments of the present disclosure, laser source 306 may include a pulsed laser diode (PLD), a vertical-cavity surface-emitting laser (VCSEL), a fiber laser, etc. For example, a PLD may be a semiconductor device similar to a light-emitting diode (LED) in which the laser beam is created at the diode's junction. In some embodiments of the present disclosure, a PLD includes a PIN diode in which the active region is in the intrinsic (I) region, and the carriers (electrons and holes) are pumped into the active region from the N and P regions, respectively. Depending on the semiconductor materials, the wavelength of laser beam 307 provided by a PLD may be smaller than 1,100 nm, such as 405 nm, between 445 nm and 465 nm, between 510 nm and 525 nm, 532 nm, 635 nm, between 650 nm and 660 nm, 670 nm, 760 nm, 785 nm, 808 nm, or 848 nm. It is understood that any suitable laser source may be used as laser source 306 for emitting laser beam 307.

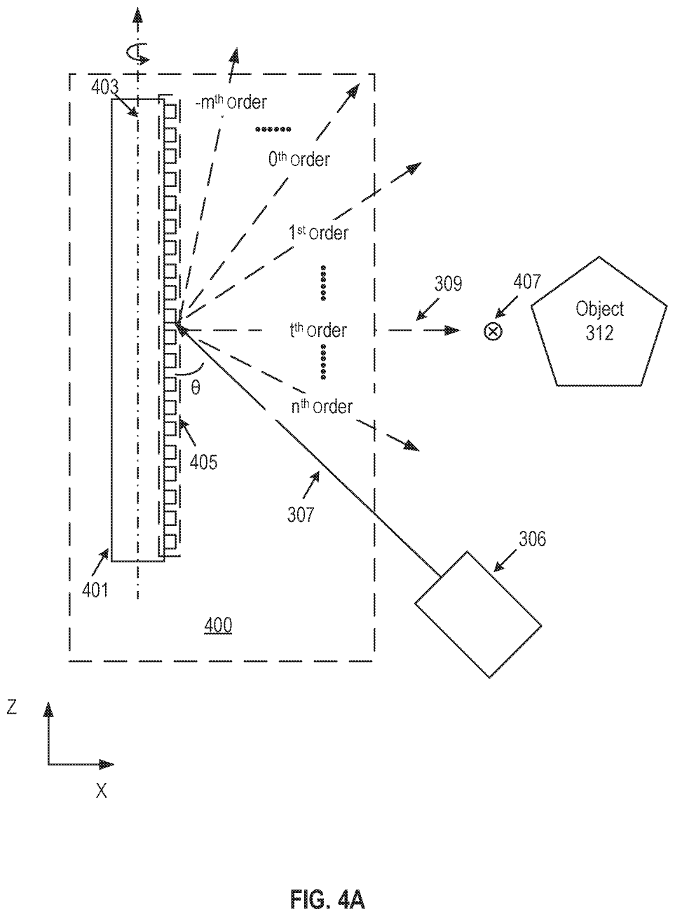

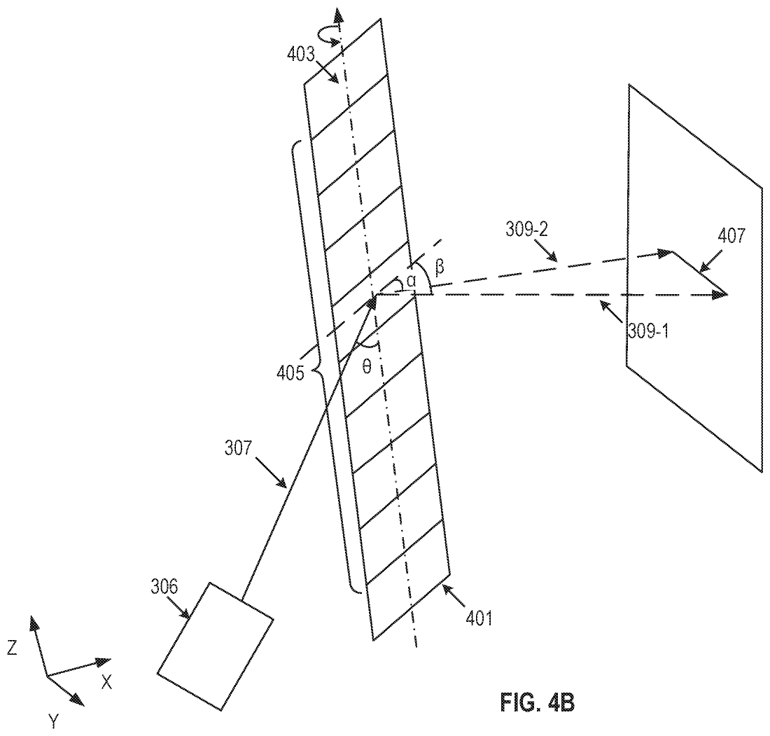

Scanner 310 may be configured to steer a laser beam 309 (also referred to as “outgoing laser beam” with respect to scanner 310) in the first direction to scan an object 312. Scanner 310 may be configured to rotate around a rotation axis (e.g., along Z axis, not shown), thus steering laser beams 309 in different directions within a scanning range extending along the Y-axis. Consistent with the present disclosure, and as will be described in more details below in connection with FIGS. 4A and 4B, scanner 310 may include a surface covered by a diffraction grating configured to diffract an incident optical beam (e.g., laser beam 307) non-orthogonal to the rotation axis of the scanner to form an outgoing optical beam (e.g., laser beam 309) substantially orthogonal to the rotation axis of scanner 310. As a result, the beam scanning path formed by the outgoing beams as scanner 310 rotates to scan the different scanning angles is substantially linear/flat.

Object 312 may be made of a wide range of materials including, for example, non-metallic objects, rocks, rain, chemical compounds, aerosols, clouds and even single molecules.

In some embodiments, receiver 304 may be configured to detect a returned laser beam 311 returned from object 312. The returned laser beam 311 may be in a different direction from laser beam 309. Receiver 304 can collect laser beams returned from object 312 and output electrical signal reflecting the intensity of the returned laser beams. Upon contact, laser light can be reflected by object 312 via backscattering, such as Rayleigh scattering, Mie scattering, Raman scattering, and fluorescence. As illustrated in FIG. 3, receiver 304 may include a lens 314 and a detector 316. Lens 314 may be configured to collect light from a respective direction in its FOV. At each time point during the scan, returned laser beam 311 may be collected by lens 314.

Detector 316 may be configured to detect returned laser beam 311 returned from object 312. In some embodiments, detector 316 may convert a laser light (e.g., returned laser beam 311) collected by lens 314 into an electrical signal 318 (e.g., a current or a voltage signal). Electrical signal 318 may be generated when photons are absorbed in a photodiode included in detector 316. In some embodiments of the present disclosure, detector 316 may include a PIN detector, a PIN detector array, an avalanche photodiode (APD) detector, a APD detector array, a single photon avalanche diode (SPAD) detector, a SPAD detector array, a silicon photomultiplier (SiPM/MPCC) detector, a SiP/MPCC detector array, or the like.

In some embodiments, LiDAR system 300 may further include one or more controllers, such as a controller 320. Controller 320 may control the operation of transmitter 302 and/or receiver 304 to perform detection/sensing operations. Specifically, controller 320 may control the scanning of transmitter 302 (e.g., the rotation of scanner 310) and may control the receiver 304 to receive the optical signals. Controller 320 may also be configured to process the optical beams received accordingly. For example, controller 320 may be configured to merge data of FOVs scanned by laser beams 307 emitted by different laser sources 306 and generate an FOV with larger scanning range (e.g., a 360-degree FOV). Controller 320 may also be configured to obtain point cloud data based on returned laser beams from the scanned FOVs. It is contemplated that to obtain point cloud data of a merged FOV, controller 320 may either merge the raw data (e.g., the captured light signals returned from the scanned FOVs) and obtain the point cloud data of the merged detecting result, or controller 320 may obtain the point cloud data of each scanned FOV and merge the point cloud data of each scanned FOV.

In some embodiments, controller 320 may include components (not shown) such as a communication interface, a processor, a memory, and a storage for performing various control functions. In some embodiments, controller 320 may have different modules in a single device, such as an integrated circuit (IC) chip (implemented as, for example, an application-specific integrated circuit (ASIC) or a field-programmable gate array (FPGA)), or separate devices with dedicated functions.

In some embodiments, the processor of controller 320 may include any appropriate type of general-purpose or special-purpose microprocessor, digital signal processor, or microcontroller. The memory or storage may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. For example, the memory and/or the storage may be configured to store program(s) that may be executed by the processor to control the operation of scanner 310.

FIGS. 4A and 4B each illustrates a schematic diagram of an exemplary scanner 400 for scanning object 312, according to embodiments of the disclosure. Scanner 400 may correspond to scanner 310 in FIG. 3. It is understood that the relative spatial relationships between or among components shown in FIGS. 4A and 4B are for illustrative purpose only. Any suitable arrangement according to the principle disclosed herein can be used for arranging components of scanner 400 according to various embodiments disclosed herein.

As illustrated in FIG. 4A, scanner 400 may include a surface 401 configured to diffract an incident optical beam (e.g., laser beam 307) to form an outgoing optical beam (e.g., laser beam 309) for scanning object 312 at a plurality of scanning angles (e.g., within an angular rang of 45-degree, 60-degree, etc.). In some embodiments, scanner 400 may include a rotational mirror configured to rotate around a rotation axis 403 (e.g., along Z axis) for steering the outgoing optical beam at the scanning angles. In some other embodiments, scanner 400 itself may rotate around rotation axis 403 (e.g., scanner 400 being a polygon scanner).

In some embodiments, surface 401 may be covered with a diffraction grating, such that an incident laser beam (e.g., laser beam 307) non-orthogonal to rotation axis 403 may be diffracted to form an outgoing laser beam (e.g., laser beam 309) orthogonal to rotation axis 403 for scanning object 312. For example, surface 401 may include periodic ridges 405. In some embodiments, the diffraction grating may be designed based on at least an incident angle θ of laser beam 307 and the wavelength of laser beam 307. The incident angle θ is the angle between laser beam 307 and rotation axis 403. Consistent with the present disclosure, incident angle θ does not have to be 90°. In some embodiments, various parameters of the diffraction grating may be determined to design the diffraction grating according to sub-wavelength grating design rules known by a person skilled in the pertinent art. In some embodiments, these parameters of the diffraction grating may include e.g., the depth of each ridge of periodic ridges 405, the spacing between the adjacent periodic ridges, and the material of periodic ridges 405, etc. For example, the spacing may be the length of the pitch between each ridges of periodic ridges 405.

In some embodiments, the diffraction grating may be formed based on etching on any suitable substrate (e.g., a silicon substrate). For example, the pattern (e.g., the determined spacing) for forming periodic ridges 405 may be incorporated into suitable existing patterning masks such that the etching of the substrate for forming periodic ridges 405 can be performed with existing etching methods (e.g., dry etching, wet etching, etc.). In some embodiments, in order to increase the reflectivity of the surface, the diffraction grating may be coated with metal materials such as silver, aluminum, etc., or non-metal materials such as silicon oxides and silicon nitrides, etc. In some embodiments, the diffraction grating may be formed by etching a dielectric layer deposited on the substrate. For example, the dielectric layer may be transparent in the operating wavelength (e.g., the wavelength of the incident optical beam and the outgoing optical beam of scanner 400) and may be deposited on a top surface of the substrate. In some other embodiments, the diffraction grating may be formed by etching the substrate coated with dielectric material on its top surface. In some further embodiments, the diffraction grating may be formed by etching a suitable substrate without additional coating. For example, the etched substrate (e.g., an etched silicon substrate) would be fabricated such that it only reflects wavelengths that are transparent to silicon. The wavelengths transparent to silicon can be designed to coincide the operating wavelength of scanner 400. It is understood that the fabricating method for forming the diffraction grating is not limited to the described above. Any suitable method can be used for fabricating the diffraction grating.

In order to make the beam scanning path formed by the outgoing beams substantially linear, the outgoing optical beams (e.g., laser beams 309) have to be substantially orthogonal (e.g., having a 90-degree angle) to rotation axis 403. Based on the embodiments disclosed herein, the term “substantially” can indicate a value of a given quantity that varies within, for example, 5-10% of the defined value such as ±5%, ±7.5%, or ±10% of the defined value.

In some embodiments, by covering surface 401 of scanner 400 with the diffraction grating, an incident laser beam (e.g., laser beam 307) with incident angle θ non-orthogonal to rotation axis 403 can be diffracted to form an outgoing optical beam (e.g., laser beam 309) substantially orthogonal to rotation axis 403.

For example, after being diffracted by the diffraction grating (e.g., periodic ridges 405), laser beam 309 may have components of a plurality of orders such as from −m^{th} to n^{th} orders, where m and n are positive integers as shown in FIG. 4A. In comparison, when not covered by the diffraction grating, scanner 400 works in a “zero-order” mode (e.g., laser beam 309 only includes a 0^{th} order component) to reflect optical beams according to laws of reflection (e.g., in the same manner as with a flat mirror).

Among the plurality of orders, the component of the 0^{th} order may typically carry the majority of energy of the laser beam. However, the component of the 0^{th} order may not be necessarily orthogonal to rotation axis 403. For example, when the incident angle θ is not 90°, the 0^{th}-order component will not be orthogonal to rotation axis 403. Instead, as illustrated in FIG. 4A, the component of a non-zero order (e.g., t^{th} order, where t being a non-zero integer satisfying −m≤t≤n) may be substantially orthogonal to rotation axis 403. The t^{th} order may be determined by the specific design of periodic ridges 405 and the incident angle of the incident beam. In some embodiments, periodic ridges 405 are also designed such that energy of the component of the 0^{th} order is substantially redistributed to the component of the t^{th} order according to sub-wavelength grating design rules known by a person skilled in the pertinent art. In some embodiments, to ensure energy efficiency, a vast majority of the energy of the component of the 0^{th} order is redistributed to the component of the t^{th} order. As a result, at least 95% of the energy of the component of the incident laser beam (e.g., laser beam 307) may be redistributed to the component of the predetermined order. Accordingly, regardless whether the incident optical beam is orthogonal to rotation axis 403, the outgoing optical beam of scanner 400 may be substantially orthogonal to rotation axis 403.

In some embodiments, as scanner 400 rotates around rotation axis 403 during scanning, laser beam 309 may be steered to transmit at the plurality of scanning angles, forming a beam scanning path 407 (e.g., along Y axis, vertical to the shown plane in FIG. 4A). For example, as illustrated in FIG. 4B, laser beam 309-1 may be steered to transmit at a first scanning angle α and laser beam 309-2 may be steered to transmit at a second scanning angle β. It is contemplated that the first and the second scanning angles α and β are for illustrative purpose only and are not limited to the illustrated angles.

As illustrated in FIG. 4B, because the component of the t^{th} order carrying most energy of each outgoing optical beam is substantially orthogonal to rotation axis 403, beam scanning path 407 may be substantially linear. This may greatly increase the performance and accuracy of the optical sensing system.

In some embodiments, more than one emitter may be configured to emit laser beams 307 for scanning different FOVs. For example, after being diffracted by periodic ridges 405, laser beams 309 emitted from different emitters (e.g., laser sources 306) may be configured to form different beam scanning paths 407 covering different scanning ranges in the Y axis. In some embodiments, the data of different FOVs may be merged by a controller (e.g., controller 320 in FIG. 3) to form a larger FOV.

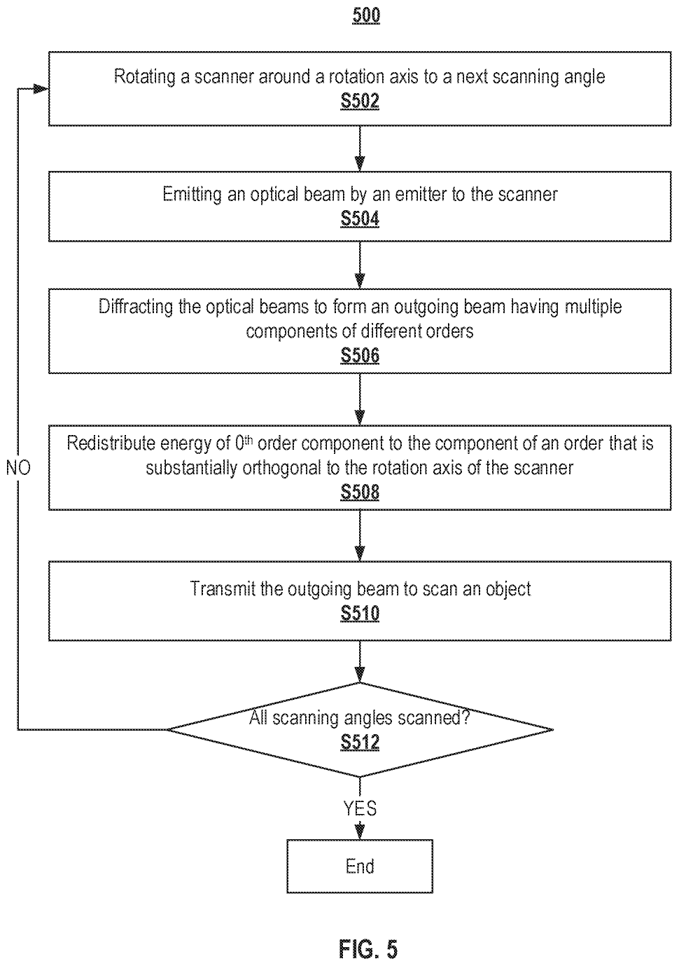

For example, FIG. 5 illustrates a flow chart of an exemplary method 500 for steering optical beams using scanner 400, according to embodiments of the disclosure. It is understood that the steps shown in method 500 are not exhaustive and that other steps can be performed as well before, after, or between any of the illustrated operations. It is to be appreciated that some of the steps may be optional. Further, some of the steps may be performed simultaneously, or in a different order than shown in FIG. 5.

In step S502, a scanner (e.g., scanner 310 in FIG. 3) may be rotated around a rotation axis (e.g., rotation axis 403 in FIGS. 4A and 4B) to scan a scanning angle (e.g., first scanning angle α in FIG. 4B). For example, the scanner may be controller by a controller (e.g., controller 320) to rotate.

In step S504, an optical beam (e.g., laser beam 307 in FIG. 3) may be emitted by an emitter (e.g., emitter 306 in FIG. 3) to the scanner. For example, the emitted optical beam may be an incident optical beam to the scanner, at an incident angle θ. Incident angle θ may not have to be substantially orthogonal to the rotation axis of the scanner.

In step S506, the optical beam may be diffracted to form an outgoing beam (e.g., laser beam 309 in FIG. 3). In some embodiments, the outgoing beam includes multiple components of different orders, and the component of a predetermined order is orthogonal to the rotation axis of the scanner. For example, the outgoing beam may have components of a plurality of orders such as from −m^{th} to n^{th} orders, where m and n are positive integers, and the component of a non-zero order (e.g., t^{th} order, where t being an integer satisfying −m≤t≤n) may be substantially orthogonal to the rotation axis.

In step S508, energy of the component of the 0^{th} order is substantially redistributed to the component of the predetermined order (e.g., t^{th} order). For example, to ensure energy efficiency, at least 95% of the energy of the component of the incident optical beam may be redistributed to the component of the predetermined order.

In step S510, the outgoing beam is transmitted to scan an object (e.g., object 312 in FIG. 3) at the current scanning angle (e.g., first scanning angle α in FIG. 4B).

In step S512, a controller (e.g., controller 320) may determine whether all scanning angles within a scanning range are scanned. For example, the scanning range can be 45-degree, 60-degree, etc. and a certain angular increment may be used to scan that range. For example, when an 1-degree increment is used, a 45-degree scanning range will be scanned at 45 different scanning angles. If all the scanning angles within the scanning range are scanned (S512: Yes), method 500 ends.

Otherwise, if not all of the scanning angles within the scanning range are scanned (S512: No), method 500 returns to step S502, where the scanner is rotated around the rotation axis to a next scanning angle (e.g., second scanning angle β). Steps S502-S512 are repeated until all scanning angles are scanned.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A transmitter of an optical sensing system, comprising:
an emitter configured to emit optical beams; and
a scanner configured to rotate around a rotation axis and steer the optical beams,
wherein a surface of the scanner is covered by a diffraction grating configured to diffract an incident optical beam non-orthogonal to the rotation axis of the scanner to form an outgoing optical beam substantially orthogonal to the rotation axis of the scanner.

2. The transmitter of claim 1, wherein the diffraction grating comprises a plurality of periodic ridges, wherein a spacing of the periodic ridges is determined based on an angle of the incident optical beam and a wavelength of the incident optical beam.

3. The transmitter of claim 2, wherein the scanner comprises a rotational mirror configured to rotate around the rotation axis.

4. The transmitter of claim 1, wherein the outgoing optical beam has components of a plurality of orders, wherein the component of a predetermined order is substantially orthogonal to the rotation axis of the scanner.

5. The transmitter of claim 4, wherein the plurality of orders include a 0^{th} order and the predetermined order, wherein the diffraction grating is configured to redistribute an energy of the component of the 0^{th} order to the component of the predetermined order.

6. The transmitter of claim 5, wherein the diffraction grating is configured to redistribute at least 95% of the energy of the component of the incident optical beam to the component of the predetermined order.

7. The transmitter of claim 1, wherein the diffraction grating is formed by etching silicon substrate coated with metal or dielectric material on the surface of the scanner.

8. The transmitter of claim 1, wherein the scanner is configured to rotate around the rotation axis to steer the outgoing optical beam at a plurality of scanning angles, wherein the outgoing optical beam moves along a beam scanning path at the plurality of scanning angles, wherein the beam scanning path is substantially linear.

9. The transmitter of claim 8, wherein the outgoing optical beam scans an object at the plurality of scanning angles to obtain orthogonal point cloud data.

10. The transmitter of claim 1, wherein the optical sensing system is a Light Detection and Ranging (LiDAR) system.

11. A method for scanning an object using an optical sensing system, comprising:
emitting an optical beam, by an emitter, incident on a scanner non-orthogonal to a rotation axis of a scanner;
diffracting the incident optical beam, by the scanner, to form an outgoing optical beam, wherein the outgoing optical beam has components of a plurality of orders, and wherein the component of a predetermined order is substantially orthogonal to the rotation axis of the scanner; and
steering the component of the predetermined order of the outgoing optical beam to scan the object.

12. The method of claim 11, wherein diffracting the incident optical beam further comprises redistributing an energy of a component of a 0^{th} order to the component of the predetermined order.

13. The method of claim 12, wherein redistributing the energy of the component of the 0^{th} order to the component of the predetermined order further comprises redistributing at least 95% of the energy of the component of the incident optical beam to the component of the predetermined order.

14. The method of claim 11, further comprising rotating the scanner around the rotation axis to steer the component of the predetermined order of the outgoing optical beam at a plurality of scanning angles, wherein the component of the predetermined order of the outgoing optical beam moves along a beam scanning path at the plurality of scanning angles, and wherein the beam scanning path is substantially linear.

15. The method of claim 11, further comprising:
detecting by a receiver, the component of the predetermined order of the outgoing optical beam reflected by the object; and
obtaining point cloud data based on the detected component.

16. An optical sensing system, comprising:
an emitter configured to emit optical beams;
a scanner configured to rotate around a rotation axis and steer the optical beams, wherein a surface of the scanner is covered by a diffraction grating configured to diffract an incident optical beam non-orthogonal to the rotation axis of the scanner to form an outgoing optical beam substantially orthogonal to the rotation axis of the scanner; and
a receiver configured to detect steered optical beams reflected by an object.

17. The optical sensing system of claim 16, wherein the diffraction grating comprises a plurality of periodic ridges, wherein a spacing of the periodic ridges is determined based on an angle of the incident optical beam and a wavelength of the incident optical beam.

18. The optical sensing system of claim 16, wherein the outgoing optical beam has components of a plurality of orders, wherein the component of a predetermined order is substantially orthogonal to the rotation axis of the scanner.

19. The optical sensing system of claim 18, wherein the plurality of orders include a 0^{th} order and the predetermined order, wherein the diffraction grating is configured to redistribute at least 95% of an energy of the component of the incident optical beam to the component of the predetermined order.

20. The optical sensing system of claim 16, wherein the scanner is configured to rotate around the rotation axis to steer the outgoing optical beam at a plurality of scanning angles, wherein the outgoing optical beam moves along a beam scanning path at the plurality of scanning angles, wherein the beam scanning path is substantially linear.
